(19) United States
(12) Patent Application Publication
(10) Pub. No.: US 2003/0163283 A1
(43) Pub. Date: Aug. 28, 2003

(54) Exercise monitoring apparatus

(76) Inventor: Conor O'Brien, Dublin (IE)

Correspondence Address: Jay H Maioli, Cooper & Dunham, 1185 Avenue of the Americas, New York, NY, 10036, US

(21) Appl. No.: 10/220,918

(22) PCT Filed: Mar. 15, 2001
(86) PCT No.: PCT/IE01/00035

(30) Foreign Application Priority Data
Mar. 15, 2000 (IE) S 2000/0207
Dec. 15, 2000 (IE) S 2000/1008

(51) Int. Cl. G01B 11/02

(52) U.S. Cl. 702/160

(57) ABSTRACT

An exercise monitoring apparatus comprising a training shoe 10 including a sensor 12 for generating a signal which varies according to the activity of the foot. A microcontroller 18 analyses the sensor signal to detect each footfall, and a radio transmitter 20 transmits data packets related to the number of footfalls detected over time. A wrist unit 24 receives the data and processes it to calculate a quantity based upon the received data, and includes a display 34 for displaying the calculated quantity.

This invention relates to an exercise monitoring apparatus.

According to the present invention there is provided an exercise monitoring apparatus comprising a component arranged to be worn on a foot of a subject whose exercise is to be monitored, the component including a sensor for generating a signal which varies according to the activity of the foot on which the sensor is worn, means for analysing the signal to detect each footfall, and a radio transmitter for transmitting data related to the number of footfalls detected over time, the apparatus further comprising a portable radio receiver for receiving the transmitted data, the receiver further including processing means for calculating a quantity based upon the received data and a display means for displaying the calculated quantity.

Preferably, the component comprises an article of footwear (hereinafter referred to as a “shoe”).

Alternatively, the component comprises a band in which said sensor and transmitter are located and said band is adapted to be worn on the foot of the subject. Further preferably, the band is adapted to be worn on the foot of an animal.

Preferably the radio receiver has a wristband for wearing in the manner of a wristwatch.

In a basic embodiment of the invention the transmitted signal may simply be a series of pulses each corresponding to a respective footfall detected by the sensor.

Preferably, however, the transmitter transmits a series of short data packets at fixed intervals, for example, one burst every second, each packet specifying the number of footfalls detected since the immediately preceding packet. In particular, each packet preferably specifies the running total of footfalls detected modulo N where N is a fixed integer.

The processing means may simply count the detected footfalls defined by the received signal and display the running total on the display means, or a derivative quantity such as rate of footfall or an aerobic function may be calculated and displayed.

Embodiments of the invention will now be described, by way of example, with reference to the accompanying drawings, in which:

FIG. 1 shows an apparatus according to a first embodiment of the invention;

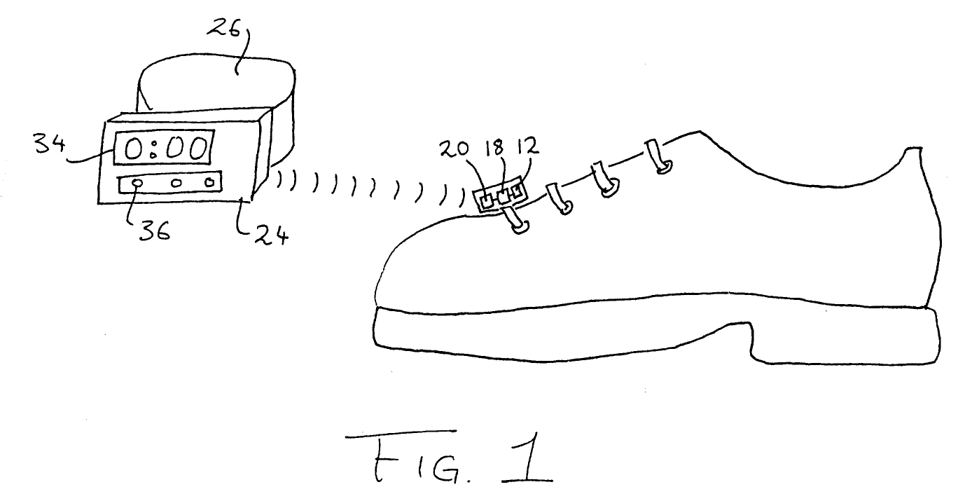

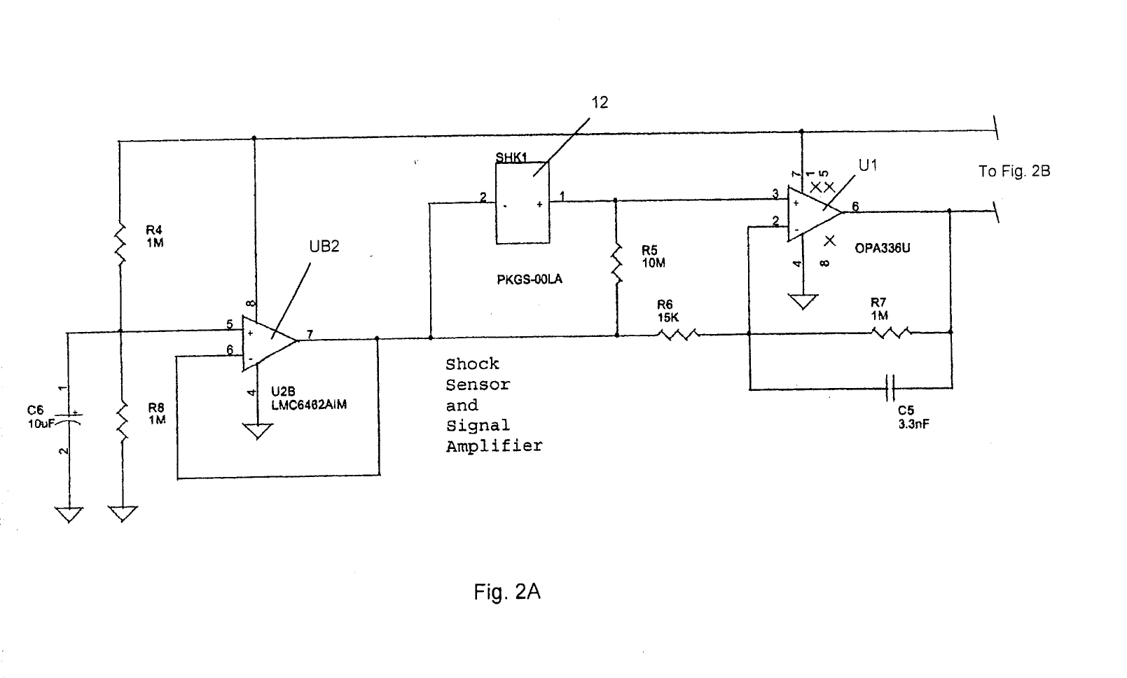

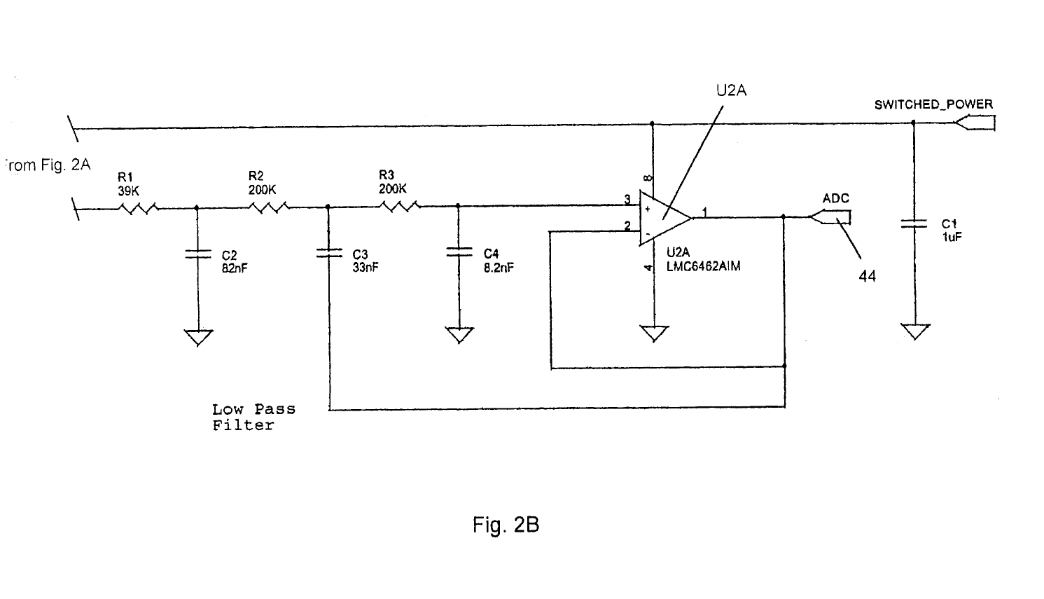

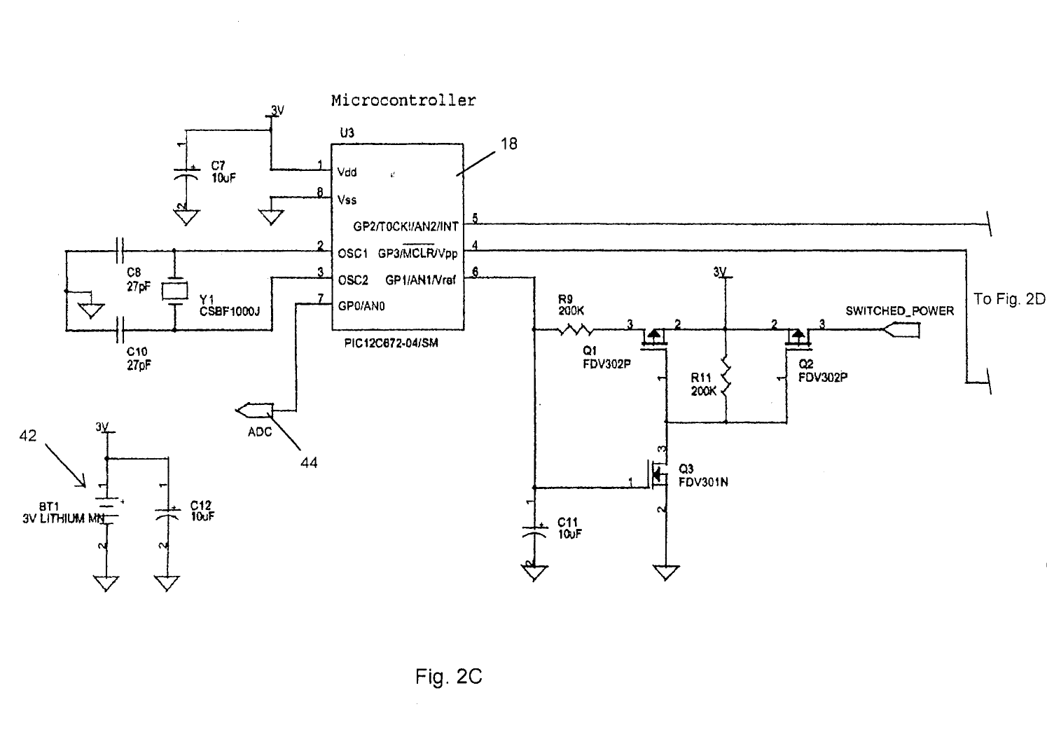

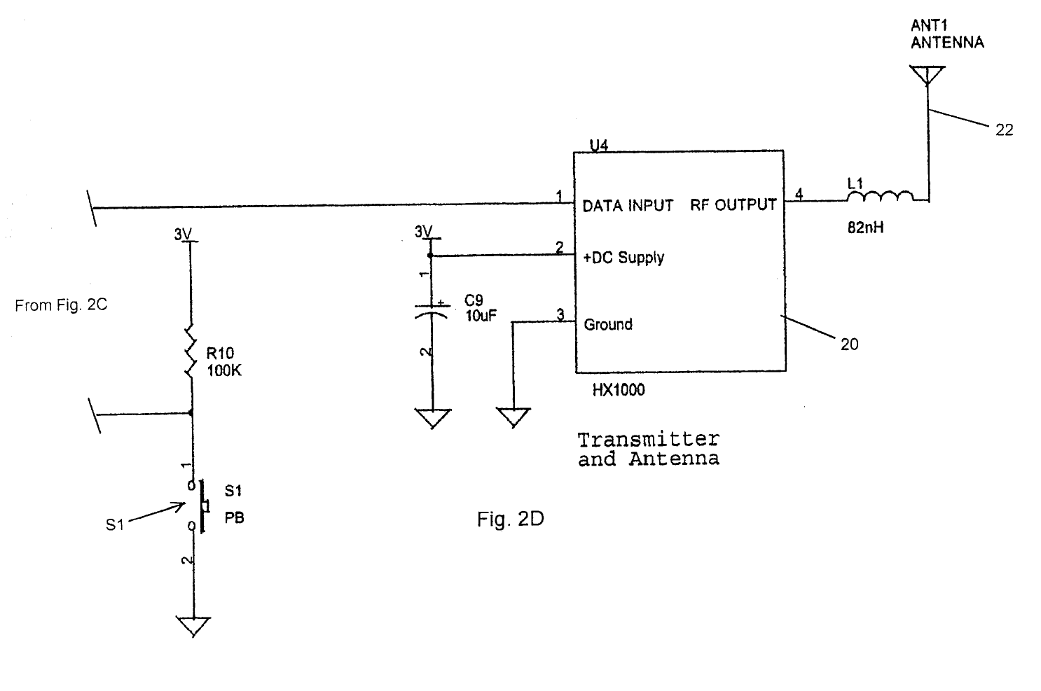

FIGS. 2A to 2D show the circuitry in the shoe of FIG. 1;

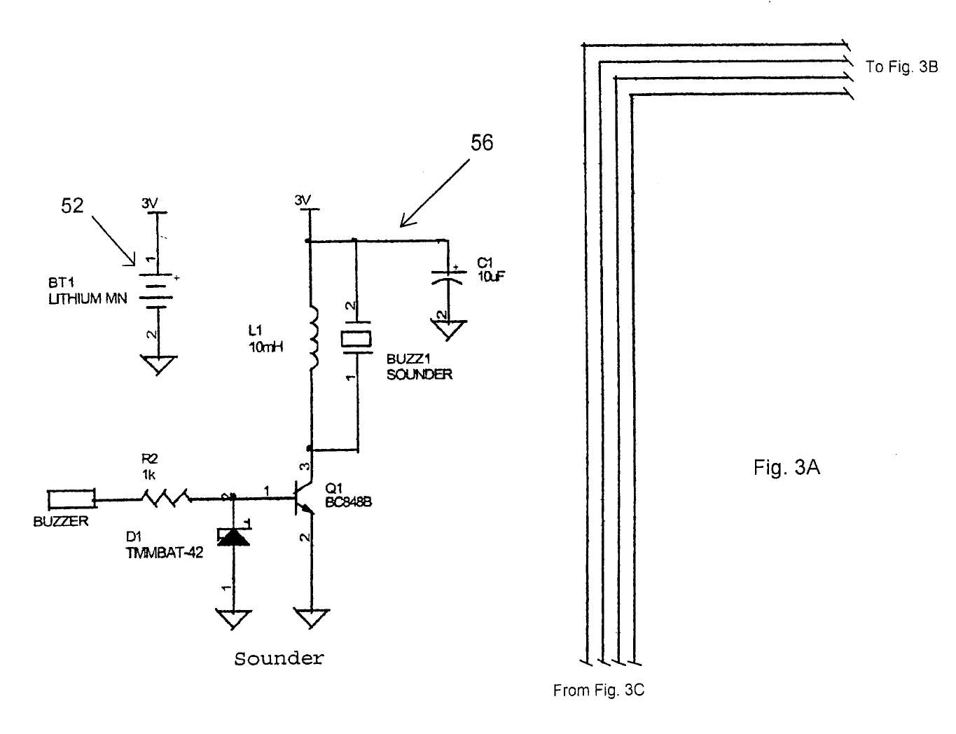

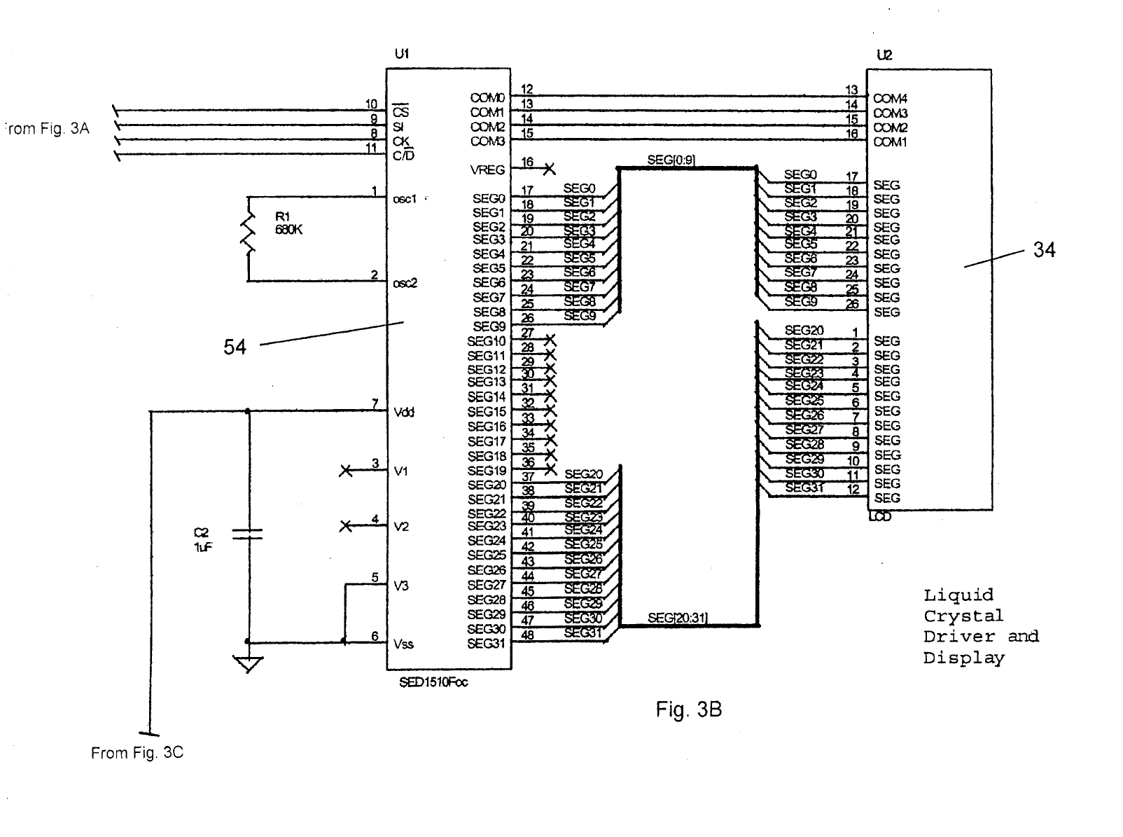

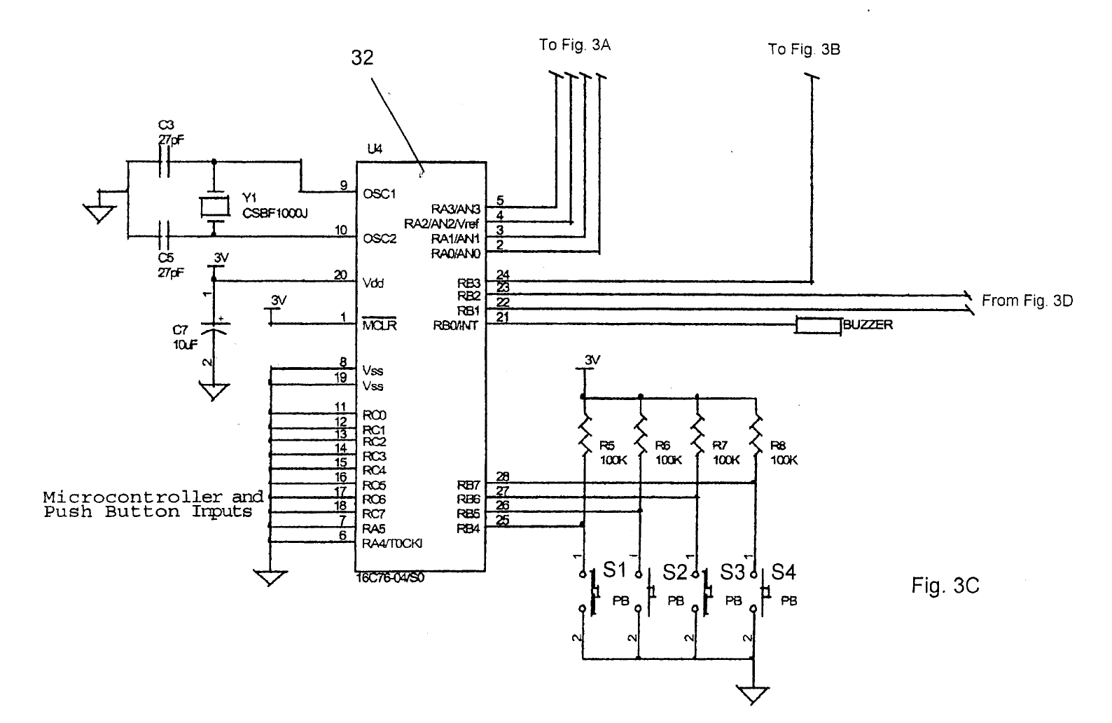

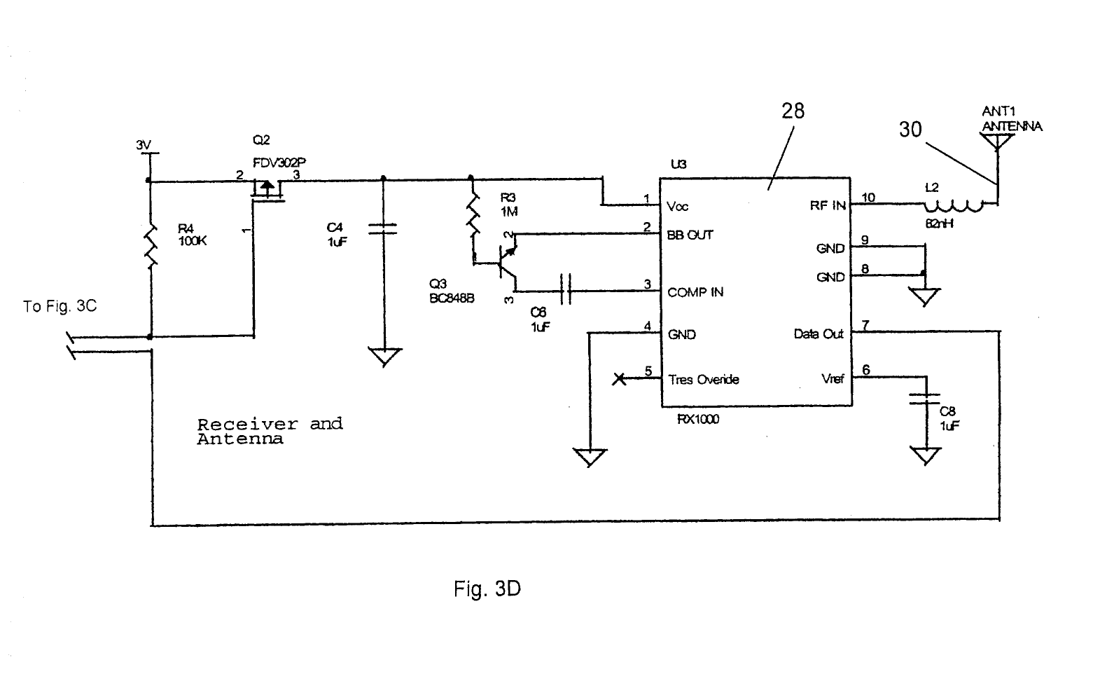

FIGS. 3A to 3D show the circuitry in the receiver of FIG. 1;

FIG. 4 is a drawing of a horse and rider employing the apparatus according to a second embodiment of the invention;

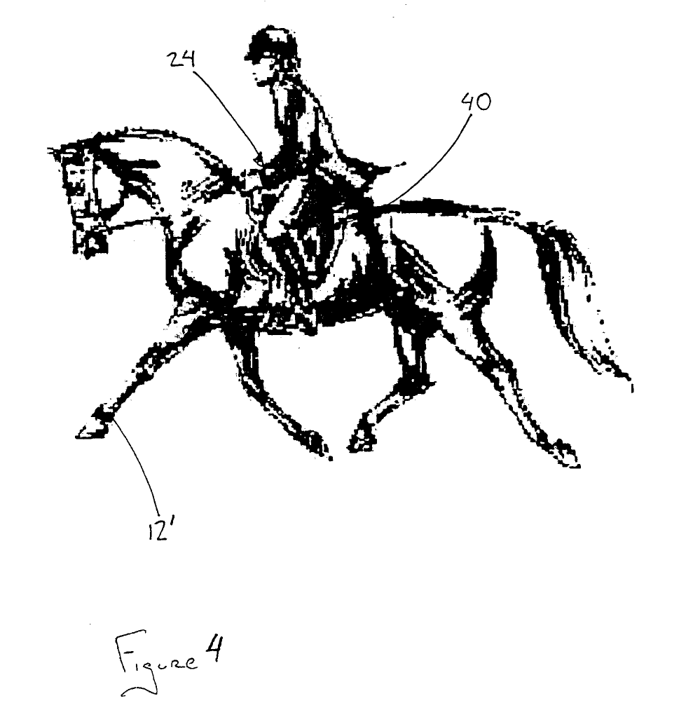

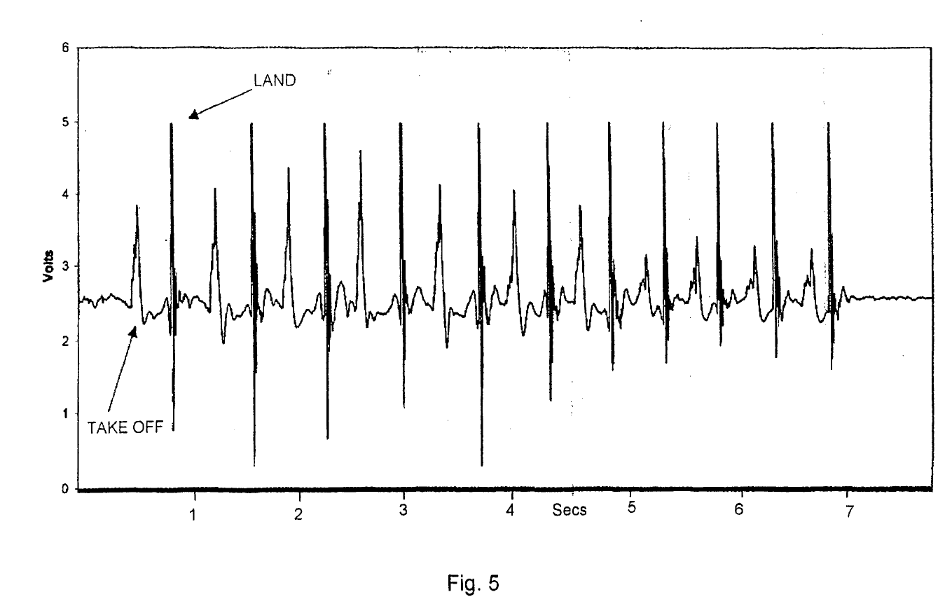

FIG. 5 shows a typical output from the piezo device in the shoe of FIG. 1; and

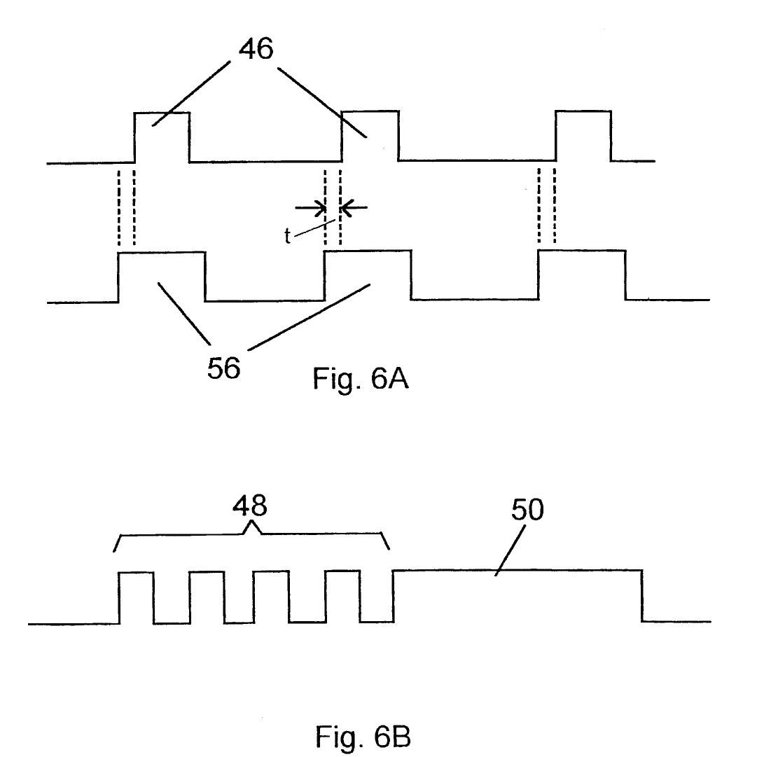

FIGS. 6A and 6B are waveforms illustrating the operation of the apparatus.

Referring to the drawings, the apparatus of FIG. 1 comprises an athletic shoe 10 of the type known as a trainer A sensor 12 is mounted on the lace of the shoe and provides an output signal which, after low pass filtering (FIG. 2B), is supplied to a microcontroller 18 also mounted in the same unit on the lace of the shoe. The sensor 12 may be any type which provides an output signal from which it is possible for the microcontroller 18 to detect the footfalls of a person wearing the shoe. Thus it may be, for example, an accelerometer, a piezoresistive or piezoelectric device, or it could be an air bladder built into the sole of the shoe operating a microswitch. The over the gait cycle of the wearer so that successive footfalls can be distinguished.

In the present embodiment the sensor 12 is an Analog Devices Accelerometer Type ADXL05. Alternatively, however, a piezoelectric wire-based sensor (not shown) may be used. This can be built into a lace of the shoe, and is essentially a coaxial cable with a piezoelectric dielectric. This primarily responds to changes in the shape of the foot as the wearer moves, such changes causing a cyclical pattern of stress on the lace and, accordingly, the sensor within.

The microcontroller 18 analyses the cyclical waveform of the sensor output signal as the wearer is walking, running, etc., to detect a well-defined point on each period of the waveform, for example, the peak value. This is registered by the microcontroller 18 as a footfall by the wearer (the footfall, i.e. the point at which the foot strikes the ground, does not actually have to occur at the detected point, so long as only one such point is detected during each gait cycle of the wearer, which must, of course, include one footfall). FIG. 5 illustrates the output waveform of a typical sensor 12 while the subject is jumping. It can be seen that the take off and landing points (labelled as such in the figure) are readily identifiable and independent of the overall amplitude of the signal.

Finally the shoe 10 includes an inbuilt low power RF transmitter 20 where data including the running total of the number of detected footfalls is transmitted to a wrist unit 24 by an antenna 22, FIG. 2D. The antenna 22 may be embedded around the peripheral edge of the sole of the shoe 10, or elsewhere in or on the shoe. The wrist unit 24 has a wristband 26 so that it may be worn in the manner of a watch. The wrist unit 24 accepts the data from the foot unit, processes it using an algorithm dependent on the selected mode of operation, and displays it in the required format on a liquid crystal display (LCD) 34.

FIGS. 2A to 2D shows the circuit in the shoe 10 in more detail. The circuit is powered by a single Li—Mn cell 42 (FIG. 2C). U2B and associated components (FIG. 2A) provide a “mid-rail” reference to allow the piezoelectric sensor 12 to operate in a bipolar mode—accommodating both foot falls and lifts. The sensor 12 generates small voltages as the sensor is accelerated due to foot movements, steps, jumps, etc. This signal is amplified by U1 and fed into a low pass, third order Butterworth filter, U2A and associated components (FIG. 2B). The two objectives of the filtering are (a) to reduce broadband noise and (b) eliminate mains or line noise (mains hum). A major source of mains frequency noise is due to mechanical coupling of vibration from motors and drive gear train onto the piezoelectric sensor. This is especially true when a The amplified and filtered signal is fed into an on-chip 8-bit analog to digital converter 44 of the PIC microcontroller 18, FIG. 2C. As the apparatus is designed to operate as an activity detector (very low impact—walking), an ergo-meter (medium to high impact) and a jumps tester (very high impact) the sensitivity of the circuit in the shoe 10 can be adjusted to accommodate a wide range of input levels. This is accomplished by switch S1 (FIG. 2D) which functions as a manual on/off (“power down”) switch and a sensitivity control (wrap around). If pressed for a short period, it is interpreted as “increment sensitivity”. If pressed for a long period, e.g. several seconds, it is interpreted as a power down signal whereupon the microcontroller 18 powers down the shoe circuitry to minimize power consumption when the unit is “off”. The microcontroller 18 is also programmed to automatically power down the shoe circuitry if a footfall is not detected during a predetermined relatively long time period. On power down the microcontroller 18 inserts a “power down” signal in the data sent to the wrist unit and stops execution of instructions except when “woken up” by an internal “watchdog” time circuit.

Software embedded in the microcontroller 18 performs an analysis of the digital signal, picking out where foot strikes occur and (in the case of jump tests) where the foot leaves the ground. The running total of detected footfalls is counted in a modulo-N counter, where N is a fixed integer. In the present embodiment a modulo-16 counter (0 to 15) is used to count the footfalls. The software also measures the running total of “time off the ground”, i.e. the accumulation of all the time periods between the foot leaving the ground and the next foot strike. These are the time periods between the two points indicated in FIG. 5. The “time off the ground” periods are measured in units of 10 msec and counted by another modulo counter, in this embodiment a modulo-200 counter (i.e. counting is over consecutive two second intervals).

To minimise power consumption of the circuits in both the shoe 10 and the wrist unit 24, the circuit (FIGS. 2A to 2D) in the shoe 10 transmits data to the wrist unit in the form of discrete data packets 46 (FIG. 6A), one per second. Each data packet (FIG. 6B) comprises a preamble 48 (consisting in this embodiment of a stream six ‘1’s and one ‘0’) which is used to synchronise the data packet and stabilise the wrist unit receiver after power up, and a main data-carrying portion 50. The latter contains digital data defining an ID unique to the particular shoe 10 (for recognition by the corresponding wrist unit 24), the running total of detected footfalls modulo-16, the running total of time off the ground modulo-200, the currently selected sensitivity level, a “power down” signal (if the shoe circuit has powered down as described above), and an FIGS. 3A to 3D show the circuit in the wrist unit 24. The circuit is powered by a single Li—Mn cell 52 (FIG. 3A) and includes a radio receiver 28 (FIG. 3D) and antenna 30 for receiving the data packets 46 transmitted by the transmitter 20. An LCD controller 54 (FIG. 3B) interfaces the microcontroller 32 to the LCD 34.

The microcontroller 32 decodes the data in the packets and, knowing the modulo cycles of the transmitter, can readily calculate the running total of footfalls detected by the sensor 12 and the running total of time off the ground (by dividing the latter by the former the average individual time off the ground can easily be calculated). Depending on the mode of operation of the wrist unit, different algorithms are selected to process this data and present it in a form that is suitable for display on the LCD 34. Momentary contact switches S1 to S4 (FIG. 3C), operated by function buttons 36 (FIG. 1), are used to select modes and start tests as required. The wrist unit 24 is capable of signaling to the user the start-stop of tests, as required, by a buzzer 56 (FIG. 3A).

On initial power up, the wrist unit 24 hunts for transmissions by monitoring the RF channel of the shoe transmitter 20 on a continuous basis. Once a valid transmission is identified, that is to say, a data stream with the correct baud rate structure, start and stop bits in the correct locations plus a valid check sum, the wrist unit 24 synchronises with it and monitors the RF channel only when a transmission is expected. In other words, since the microcontroller 32 knows the interval at which the data packets are transmitted (once every second in this embodiment), once the microcontroller is synchronised with the data packets during an initial synchronisation period, it turns on (“powers up”) the wrist unit circuit just prior to when it expects to receive a data packet and powers the circuit down just after it has received a data packet. This is shown in FIG. 6A, where the “on” periods 56 of the wrist unit circuit commence a short time “t” before the expected arrival of the next data packet 46. In other words, once every second the wrist unit 24 automatically powers up to create a receiving window just longer than the duration of the data packet. This reduces the current consumption of the wrist unit by an order of magnitude. The microcontroller 32 keeps track of time by counting signals from a crystal controlled oscillator.

Due to the use of modulo counting in the shoe 10, the microcontroller 32 is able to interpolate the data from missing or corrupt data packets, i.e. data packets which it should have, but has not, received. Clearly, since it expects to receive a data packet every second, if it misses one or even several, or if they are corrupt, it will register that fact and can determine off the ground from the data contained in the next received data packet.

If at any time the wrist unit 24 receives a data packet 46 including a “power down” signal, indicating that the shoe circuit is powering down as described above, the microcontroller 32 will likewise power down the wrist unit circuit.

The microcontroller 32 is programmed to calculate various quantities from the received signal bursts, selected by one of the function buttons 36. According to which button is pressed the microcontroller 32 may simply count the detected footfalls defined by the received signal bursts and display the running total on the LCD 34, or a derivative quantity such as rate of footfall or aerobic functions may be calculated and displayed using established scientific formulae.

The microcontroller 32 may be programmed to convert numbers of footfalls to distance travelled, by operating in a learning mode which measures the total number of footfalls made during a walk or run over a fixed, known distance. From this, the average stride length for a particular user is derived and stored in a permanent memory, and this stride distance can be used in later operation to provide distance travelled as an output.

The wristwatch unit function buttons 36 may also be used to compensate for uphill/downhill gradients (during which the average stride length will be shortened or lengthened) by providing a facility to alter the stride length while running or walking. This may simply enable a selection of “uphill” and “downhill” modes, in which the microcontroller adjusts the average stride length by a fixed percentage (e.g. 10-15%), or it may be more sophisticated, enabling the user to select different degrees of gradients, with the microcontroller adjusting the average stride length accordingly. For example, the user might be allowed to vary the current gradient on a scale of [−5,−4,−3,−2,−1,0,+1,+2,+3,+4,+5], with the microcontroller adding or subtracting a fixed percentage to the average stride length for each step along the scale away from zero.

Apart from calculating numbers of footfalls and distance travelled, the invention may also be used to measure the maximal oxygen intake (maximal VO2) of a subject, which is the maximum amount of oxygen a subject can consume per unit time, and to subsequently display the aerobic workout rate of the subject in terms of the maximal oxygen intake. This enables the user to tailor exercise to a safe level, and to quantitatively ensure a constant workout rate.

Maximal VO2 can be determined using the Cooper's test a subject can run in twelve minutes (maximal VO2 being a constant multiplied by this distance). The constant, known as Cooper's Constant, can be stored in the memory of the wristwatch unit, and as indicated above, the device may he used to measure both distance travelled and time. Thus, the maximal VO2 may be calculated by the subject personally, and this may be stored in the memory also. Subsequently, exercise output may be calculated and displayed as a proportion of maximal VO2. A useful measure of aerobic capacity is the metabolic equivalent (MET) which is a unit of oxygen consumption per unit time, compensated for bodyweight [1 MET=3.5 ml/kg/min of oxygen]. If the maximal VO2 is calculated in METs, this will give a useful unit for the subject to measure subsequent exercise levels (e.g. the average 40 year old woman may have a maximal VO2 equivalent of 10 METs, and she may be advised to train at 50% of her capacity, which can easily be done using the device. The device provides the output in METs, and the subject knows she should aim to keep the output at 5 METs.

The invention can also be used to measure anaerobic fitness, using the Bosco jump test, which uses a formula to calculate anaerobic power output in watts from the number of jumps and time spent off the ground during a test period (usually 15 or 45 seconds).

A further way of measuring aerobic fitness is to use the 1 mile walk test, which tests the time taken for the subject to walk 1 mile. By use of the invention, the subject is not limited to carrying out this test at a facility where accurate distance measurement is provided, or in a locality where a 1 mile walk has previously been measured. Because the device measures distance itself, the test can be taken by the subject at any location.

It will be seen that the invention is not limited to the incorporation of the sensor 12 in a shoe. Referring now to FIG. 4, in a second embodiment of the invention, a sensor 12′ is incorporated in a band adapted to be worn on the foot of a horse whose exercise is to be monitored. The sensor 12′ includes similar circuitry to that of FIGS. 2A to 2D and transmits an output signal which is picked up by a receiver built into a wrist unit 24 of the type described in relation to FIG. 3 worn by a rider.

It will be seen that both embodiments can be further developed to transmit data to, for example, a base station (not shown) where the exercising subject may be remotely monitored. This is particularly useful in the second embodiment, where a GSM transmitter 40 is located in the saddle and is adapted to pick up on the signals transmitted by the sensor 12′ or an adapted wrist unit 24. This communication can preferably be implemented using Bluetooth compatible wireless communication—for more information about Bluetooth relays the data being generated to a base station where the data can be analysed and/or stored.

The invention is not limited to the embodiments described herein which may be modified or varied without departing from the scope of the invention.

1. An exercise monitoring apparatus comprising a component arranged to be worn on a foot of a subject whose exercise is to be monitored, the component including a sensor for generating a signal which varies according to the activity of the foot on which the sensor is worn, means for analysing the signal to detect each footfall, and a radio transmitter for transmitting data related to the number of footfalls detected over time, the apparatus further comprising a portable radio receiver for receiving the transmitted data, the receiver further including processing means for calculating a quantity based upon the received data and a display means for displaying the calculated quantity.

2. An apparatus as claimed in claim 1, wherein the component comprises an article of human footwear.

3. An apparatus as claimed in claim 1, wherein the component comprises a band in which said sensor and transmitter are located and said band is adapted to be worn on the foot of the subject.

4. An apparatus as claimed in claim 1, wherein the radio receiver has a wristband for wearing in the manner of a wristwatch.

5. An apparatus as claimed in any preceding claim, wherein the transmitter transmits a series of data packets at fixed intervals.

6. An apparatus as claimed in claim 5, wherein the radio receiver automatically powers up shortly before a data packet is expected and powers down afterwards.

7. An apparatus as claimed in claim 5 or 6, wherein each data packet contains data related to the number of footfalls detected since the immediately preceding data packet.

8. An apparatus as claimed in claim 7, wherein each data packet specifies the running total of footfalls counted by modulo counting.

9. An apparatus as claimed in claim 5, 6, 7 or 8, wherein the analysing means also detects each foot take-off, and each data packet also contains data related to time off the ground.

10. An apparatus as claimed in claim 9, wherein each data packet specifies the running total of time off the ground counted by modulo counting.

11. An apparatus as claimed in any preceding claim, wherein the sensor is a piezoelectric or piezoresistive device.

12. An apparatus as claimed in any preceding claim, wherein the sensor signal is filtered to remove mains frequency noise.

13. An apparatus as claimed in any preceding claim, wherein the component automatically powers off if no footfall is detected during a predetermined time period.

14. An apparatus as claimed in any preceding claim, wherein the transmitted data identifies if the component is powered off, and the receiver likewise powers off automatically in response thereto.
